(19) United States
(12) Patent Application Publication
(10) Pub. No.: US 2004/0180726 A1
(43) Pub. Date: Sep. 16, 2004

(54) Rotatably balanced shaft and balancing method

(76) Inventors: Todd D. Freeman, Dearborn Heights, MI (US); Gary E. Kopp, Shelby Township, MI (US)

Correspondence Address: Dickinson Wright PLLC, Suite 800, 1901 L. Street NW, Washington, DC, 20036, US

(21) Appl. No.: 10/386,052

(22) Filed: Mar. 11, 2003

(51) Int. Cl. F16C 3/00

(52) U.S. Cl. 464/180

(57) ABSTRACT

A rotationally balanced shaft assembly having a shaft and a bead of balancing material. The shaft has an axial length and an outer surface. The bead is adhered to the outer surface of the shaft and has a length that is greater than its width. The rotationally balanced shaft is also defined as having an initial imbalance angular position along the outer surface of the shaft with the bead being centered on the angular position along the length of the bead. The invention is also directed to a method of balancing a shaft using a balancing material applicator. The method includes the steps of determining an imbalance of the shaft, aligning the balance material applicator, and the angular position of the initial imbalance, and dispensing balancing material from the applicator while causing relative axial movement between the applicator and the shaft.

### BACKGROUND OF THE INVENTION

The present invention is directed to a method for balancing a rotatable shaft that includes that application of an adhesive balancing material and a balanced shaft including an bead of the balancing material.

Rotating shafts are used in a variety of power transfer applications. For example, in automobiles and other powered vehicles, rotatable shafts are used to transfer power between the engine and the transmission, the transmission and various differential or transfer cases, and along vehicle drive axles. In each of these and other analogous situations, the rotational balance of the shaft is particularly important. For example, in motor vehicle applications, an unbalanced shaft contributes to undesirable noise, vibration, and handling difficulties that may be particularly bothersome to consumers and negatively impact vehicle sales.

Conventional methods and systems for balancing rotatable shafts, such as those used in motorized vehicles, include the use of a drive shaft balancer to identify the magnitude and angular location of the shaft imbalance point. Available shaft balancers rotate the shaft and commonly determine the imbalance at each shaft end. The balancer indicates the mass or weight to add to each end of the shaft and the circumferential location for the addition. In traditional balancing operations, a specific size weighted plate, commonly comprised of steel or aluminum, is selected and attached to the shaft. The weights are commonly available in incremental sizes, such as in 0.08 ounce increments for the balancing of automobile drive shafts. In such systems, the precision of balance correction is limited by the incremental size of the plates. Moreover, the plates extend circumferentially about the shaft such that each plate does not contribute precisely to balance correction.

Other methods and systems for balancing rotatable shafts include the use of curable adhesives. One conventional system uses a balancing material having high density particulates, such as metals, dispersed in a carrier, such as a polymer. The material is adhered at selected locations on the outer surface of a driveshaft to provide rotational balancing. The material is cured through the use of an energy source such as a heater or ultraviolet light generator. Notwithstanding this general teaching of the use of a curable balancing material, the application of the balancing material is conventionally performed without regard to the circumferential extent of the corrective material. Moreover, the balancing material is not axially extended along the shaft at a specific and constant angular position.

In sum, the prior art fails to recognize or address several deficiencies in the art including the desirability of minimizing the extent to which the balance correcting material extends about the circumference of the shaft, the benefits of an axially extending bead, and other bead configuration concerns.

### SUMMARY OF THE INVENTION

In view of the above, the present invention is directed to a rotationally balanced shaft assembly having a shaft and a bead of balancing material. The shaft has an axial length and an outer surface. The bead is adhered to the outer surface of the shaft and has a length that is greater than its width. The rotationally balanced shaft is also defined as having an initial imbalance angular position along the outer surface of the shaft with the bead being centered on the angular position along the length of the bead. The invention is also directed to a method of balancing a shaft using a balancing material applicator. The method includes the steps of determining an imbalance of the shaft, aligning the balance material applicator, and the angular position of the initial imbalance, and dispensing balancing material from the applicator while causing relative axial movement between the applicator and the shaft.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates a shaft balancing apparatus according to the present invention;

FIG. 2 is a schematic illustration of certain components of the shaft balancing apparatus shown in FIG. 1;

FIG. 3 is a perspective view of a balanced shaft according to the present invention; and

FIG. 4 is a sectional view of the shaft taken along the line 4-4 shown in FIG. 3.

### DETAILED DESCRIPTION OF THE PREFERRED EMBODIMENT

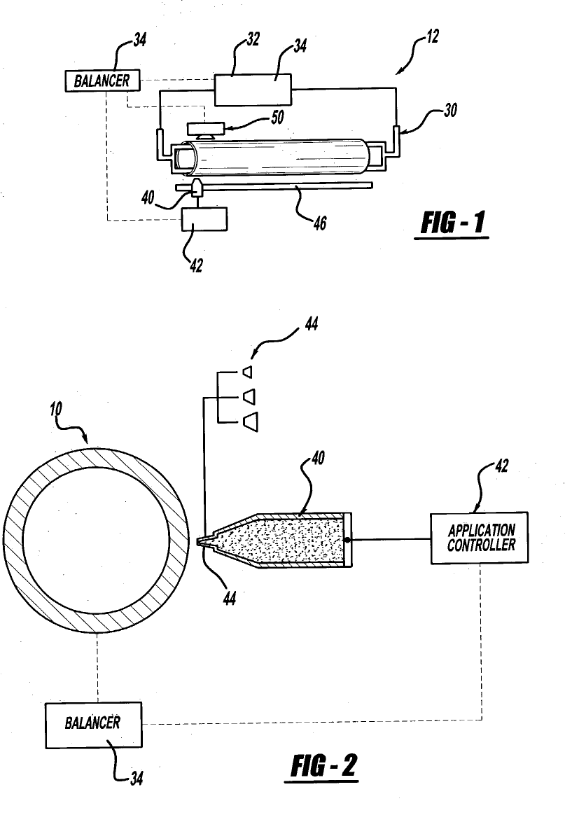

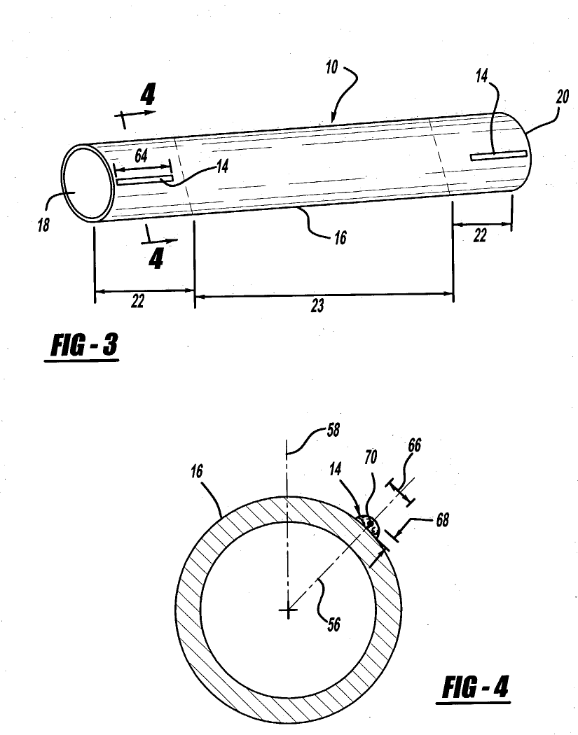

FIG. 1 illustrates a balanced shaft 10 mounted to a balancing apparatus 12. The shaft 10 is illustrated in FIGS. 1 and 2 to include one or more beads 14 of balancing material adhered to an outer shaft surface 16. The shaft 10 is generally cylindrical in configuration and has first and second ends 18 and 20. The beads 14 are illustrated as being wholly contained within a predetermined distance axially inward from the ends as defined by a balancing area 22, the axial length of which may vary based on the type of shaft and other variables. For example, in shafts used to transfer torque in the drivetrain of an automobile, the center, balancing material free, section 23 of the shaft is commonly dedicated for uses such as coupling the shaft to the vehicle frame, attachment of suspension components, and the like. For the axle shaft contemplated for the present invention, each of the balancing areas 22 generally have a length of approximately 10% of the overall shaft length. Notwithstanding this exemplary illustration, those skilled in the art will appreciate that, for shafts not having dedicated areas for balancing material, the balancing material may be adhered to the shaft in virtually any axial location.

In the illustrated embodiment, the balancing apparatus 12 generally operates to determine the magnitude and angular position of the initial rotational imbalance of a shaft and apply a bead of balancing material to the shaft. To effect these functions, the balancing apparatus generally includes a shaft mounting assembly 30, a driver 32 configured to rotate the mounting assembly and shaft, and a balancer 34 that controls the rotation of the shaft. The mounting assembly is shown to include rotatable couplings 36 driven by the driver 32 and attachable to each end of the shaft. The balancer 34 is configured to determine the magnitude and angular position of the initial rotational imbalance of the shaft in a conventional manner such as by rotating the shaft and measuring vibrations during rotation. The balancer also preferably verifies the balance of the shaft 10 following application of the balancing bead. A multitude of suitable balancers are available in the art, such as those distributed by Schenck-Tumer of Orion, Mich.

The balancing apparatus 12 also includes a balancing material applicator 40 and an application controller 42 communicating with the applicator 40 to control the dispensation of balancing material to the shaft 10. The application controller 42 communicates with the balancer 34 to facilitate proper application of the balancing material to the shaft. While the controller and balancer are schematically illustrated as separate components, those skilled in the art will appreciate that these control elements may be incorporated into a single structure such as an integrated computer or processor.

The applicator 40 preferably includes a dispensing end having a nozzle coupler that permits the use of nozzles 44 of differing sizes and configurations so as to control the size and cross-section of the beads 12. Further, for reasons that will be apparent from this description, the applicator is axially movable relative to the shaft 10. This relative axial movement is preferably obtained by mounting the applicator on an axial slide assembly 46 that is movable relative to a stationary shaft but may also be achieved by axially displacing the shaft relative to a stationary applicator. While the above described and illustrated embodiment of the invention provides automated imbalance determination and correction, it should be understood that the bead 12 may be applied manually.

The balancing apparatus 12 also preferably includes a curing element 50 that is used to cure the beads 12 of balancing material after application to the shaft. As will be discussed in detail below, it is contemplated that an adhesive balancing material curable through exposure to ultraviolet (UV) light is particularly suited for the present invention. In this case, the curing element is an emitter of suitable UV waves, such as a UV spot, beam, or flood lamp. However, the invention also contemplates the use of balancing materials that are curable by sources other than UV light as well as materials that do not require the use of a curing element, such as a thermal curing epoxy. One skilled in the art may select a suitable material based upon the application requirements such as the density, cure rate, and strength of available materials.

Returning now to the configuration of the shaft 10 and beads 14 of balancing material. Prior to balancing, the shaft has an initial imbalance of a measurable magnitude and location along the outer shaft surface 16. This imbalance point is indicated in FIG. 4 by an imbalance angle 56 measured from a reference plane 58. The bead 14 has a longitudinal length 64 and a cross sectional configuration with a width 66, a height 68, and a center of mass 70. The volume of the bead deposited on the shaft is determined by the balancer 34 and/or application controller 42 so that the weight of the applied bead is equal to the initial imbalance magnitude. It will be appreciated that the bead cross section is generally dictated by the configuration of the applicator nozzle 44, the rate that the balancing material is dispensed from the applicator 40, and the rate of relative axial movement between the applicator 40 and shaft 10.

As is discussed above, one of the unique features of the present invention is the extension of the bead axially along the shaft at a constant circumferential position with the center of mass aligned with the imbalance angle 56. By this configuration, the bead length 64 is generally greater than its width 66, with the width 66 also being substantially constant along the bead length. Further, in the present invention, it is generally desirable to minimize the width of the bead to concentrate the balancing material along a small arc length along the circumference of the shaft. By reducing the circumferential extent of the balancing material about the shaft, the effectiveness of the correction provided by the balancing material is improved. While the width of the narrow bead may vary for a particular application, for bead stability, the-height 68 of the bead is preferably no greater than its width 66.

As noted above, the balancing material is preferably a UV curable adhesive material. There are numerous suitable materials available in the art including those distributed by Dymax Corporation of Torrington, Conn. Factors of interest in selecting a suitable material may include the material density, viscosity, initial strength, cure rate, and cured strength. The density of the material impacts the volume needed to correct an initial imbalance magnitude. Therefore, it is generally desirable to maximize the material density. The viscosity impacts the stability of the bead during application. The initial strength should be sufficient to ensure proper retention of the bead on the shaft during application and curing. The cure rate should be selected to obtain the desired manufacturing volumes and sufficient bead stability during verification of the balancing. A suitable cured strength should consider the operating environment and life cycle of the shaft. For completeness, it is noted that a suitable balancing material for an automotive driveshaft preferably, though not necessarily, includes a relatively high density, on the order of at least about four (4) g/cm3, is readily adhered to and stable on the shaft upon application, and is curable to about 50% of its cure strength within about 10 seconds. Notwithstanding the foregoing description of a particularly suitable balancing material and characteristics, those skilled in the art will appreciate that a variety of alternative materials may be used without departing from the scope of the invention.

Turning now to a method for balancing a shaft according to the present invention, the method includes determining the initial imbalance of the shaft (including the magnitude and angular position of the imbalance, e.g., the imbalance angle 56), aligning the imbalance position and the applicator, and dispensing balancing material from the applicator while causing relative axial movement between the applicator and shaft. During bead application, the shaft is rotationally fixed to permit precise application of a linear bead of balancing material along a single angular location (i.e., the imbalance position) about the outer surface 16 of the shaft 10. By this process, as noted above, the resulting bead has a generally constant width and height along its length due to the predetermined nozzle configuration with the weight of balancing material applied to the shaft being controlled by selectively varying the length of the bead.

As noted above, the cross sectional configuration of the bead may be tailored for a particular shaft by selecting an appropriately configured applicator nozzle. It should be appreciated that the applicator and application controller may be configured to permit the application controller 42 to select an appropriate nozzle from a predetermined supply based on the imbalance magnitude and automatically couple the nozzle to the applicator.

Commonly used driveshafts for vehicles have diameters ranging from about 1.77 inches to about 5.0 inches. An upper initial imbalance limit is commonly used in the automotive industry to determine whether the shaft should be balanced or discarded. For initial shaft imbalances less than the upper limit, the shaft is balanced by adding weight at the determined imbalance point. When conventional balancing plates are used, the balancer indicates the imbalance point and plates are then manually positioned at the imbalance point and fixed to the shaft, such as by an epoxy. Conventional balancing plates are of such size that they commonly extend between 10 and 90 degrees along the outer shaft surface 16. For example, for a three inch outer surface diameter with an imbalance of 1.35 in-oz, a 0.90 ounce plate may be used. Commonly available plates of this mass have a diameter of approximately 1.5 inches. Thus, the plate extends along an arc of approximately 57 degrees. As a result, the weights are not effectively concentrated at the angular position of the imbalance.

With the present invention, the same imbalance in a three inch diameter shaft may be corrected using a bead of the high density UV curable adhesive balancing material distributed by Dymax Corporation having a width of approximately 10 millimeters, a height of approximately 10 millimeters, and a length of approximately 80 millimeters. Thus, the bead extends only about 15 degrees along the shaft outer surface and is centered along the angular imbalance position. The above referenced balancing material distributed by Dymax Corporation is a light curing adhesive with added particles to increase the density of the material and has a material density of approximately 4.0 g/cm³, an initial strength of approximately 500 psi, a cure rate of approximately 1000 psi per minute, and a cured strength of approximately 3,000 psi.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A rotationally balanced shaft assembly comprising:
a shaft having an axial length and an outer surface; and
a bead of balancing material adhered to the outer surface of the shaft, said bead having a length and a width, said length being greater than said width.

2. The shaft assembly of claim 1 wherein said shaft includes a balancing area at an axial end of the shaft and wherein the shaft bead is wholly contained within said balancing area.

3. The shaft assembly of claim 2 wherein said length of said bead is less than about 10% of said shaft length.

4. The shaft assembly of claim 1 wherein said balancing material is a UV curable material.

5. The shaft assembly of claim 1 wherein said balancing material is viscous.

6. The shaft assembly of claim 1 wherein said shaft has an initial imbalance at an angular position and wherein said bead is centered on said angular position along the length of said bead.

7. The shaft assembly of claim 1 wherein said bead has a substantially constant width along its length.

8. The shaft assembly of claim 1 wherein said bead width is substantially constant along said bead length.

9. A method of balancing a shaft using a balancing material applicator comprising:
determining an initial imbalance of the shaft, said initial imbalance having a magnitude and angular position;
aligning the balancing material applicator and the angular position of the initial imbalance; and
dispensing balancing material from the applicator while causing relative axial movement between the applicator and shaft.

10. The method of claim 9 wherein the shaft is stationary and the applicator is axially displaced relative to the shaft during the dispensing step.

11. The method of claim 9 further including maintaining the shaft rotationally stationary relative to said applicator during axial displacement.

12. The method of claim 11 further including extending the balancing material along a predetermined length of the shaft and at a constant circumferential position about the shaft until the mass of the balancing material is approximately equal to the magnitude of the initial imbalance.

13. The method of claim 9 further including determining the mass of balancing material dispensed from the applicator and discontinuing dispensation of said balancing material when the mass is approximately equal to the imbalance magnitude.

14. The method of claim 9 wherein the step of determining the mass of balancing material applied to the shaft includes determining a cross sectional configuration of a bead dispensed from the applicator and a bead length.

15. The method of claim 9 further including selecting an applicator nozzle based on the imbalance magnitude and operably coupling the nozzle to the applicator prior to the step of dispensing balancing material.

16. The method of claim 9 further including the step of curing the balancing material by subjecting the balancing material to UV light.

17. A shaft balancing apparatus comprising:
a shaft balancer;
a shaft coupled to the shaft balancer;
an applicator positioned to dispense a balancing material to the shaft;
an application controller communicating with the shaft balancer and applicator to control the dispensation of balancing material from the applicator to the shaft; and
wherein the applicator and shaft are axially movable relative to one another.

18. The shaft balancing apparatus of claim 17 wherein said balancer and application controller cooperate to maintain the shaft rotationally stationary relative to said applicator during axial movement of said applicator relative to said shaft.
